(19) United States
(12) Patent Application Publication
(10) Pub. No.: US 2026/0208275 A1
(43) Pub. Date: Jul. 23, 2026

(54) DRILLING TOOL

(71) Applicant: Ceratizit Balzheim GmbH & Co. KG, Balzheim (DE)

(72) Inventors: Rainer WALCHER, Balzheim (DE); Tebbe PAULSEN, Balzheim (DE); Peter HEIM, Balzheim (DE)

(21) Appl. No.: 19/139,995

(22) PCT Filed: Dec. 19, 2023
(86) PCT No.: PCT/EP2023/086597

§ 371 Date: Jun. 17, 2025

(30) Foreign Application Priority Data
Jan. 26, 2023 (EP) 23153360.5

(51) Int. Cl. B23B 51/02

(52) U.S. Cl. CPC B23B 51/02; B23B 2251/182

(57) ABSTRACT

A drilling tool has two main cutting edges each with an arcuate course at least in sections. The main cutting edges are connected to one another via a chisel cutting edge. The drill tool further has a drill face side, a drill longitudinal axis about which the drilling tool can be rotated in a rotational direction, a drill tip which lies on the drill longitudinal axis, two flutes which run along the drill longitudinal axis, webs which are formed between the flutes and form a land on the circumferential side, and a point thinning portion which is made in the drill face side. In relation to a frontal view of the drill face side, an opening angle of a flute is formed on the drill face side.

The present invention relates to a drilling tool with the features of the preamble of claim 1. Furthermore, a method for producing the drilling tool is specified.

A drilling tool of this type is known from EP 3 038 776(B1), for instance. According to this printed publication, a favorable removal of chips is realized by virtue of the fact that a chip run-up shoulder of a web thinning exhibits an axial angle, measured in relation to the central axis, that decreases continuously with increasing spacing from the front side.

An object of the present invention is to specify an improved drilling tool. In particular, the drilling tool is to be capable of being produced favorably, with few grinding operations. In particular, the improved drilling tool is to display an advantageous removal of chips in the case of slight machining forces.

The object is achieved by means of a drilling tool with the features of claim 1. The drilling tool according to the invention exhibits:
two main cutting edges with, at least in sections, arcuate progression, which are connected to one another via a transverse cutting edge,
a drill face, a longitudinal drill axis, about which the drilling tool is capable of being rotated in a direction of rotation,
a drill bit situated on the longitudinal drill axis,
at least two flutes extending along the longitudinal drill axis,
webs formed between the flutes, which form a land peripherally,
a web thinning introduced into the drill face,
wherein, relative to a frontal view of the drill face, an aperture angle of a flute on the drill face in the case of a conical-surface grinding is spanned between:
   an imaginary connection of the drill bit to a cutting corner of the main cutting edge and
   an imaginary connection of the drill bit to a rear corner which has been formed on the land at the transition of the flank into the flute,
in the case of a surface grinding, the aperture angle is spanned between:
   an imaginary connection of the drill bit to a cutting corner of the main cutting edge and
a section of a contour of the web thinning extending radially outward, which aperture angle amounts to between 85° and 95°,
and the web thinning has been introduced into the drill face in such a manner that a normal spacing from an interior point of the web thinning from an imaginary connection of the drill bit to a cutting corner is less than or equal to the normal spacing of a transition-point between the main cutting edge, adjoining the web thinning, and the transverse cutting edge from the imaginary connection of the drill bit to a cutting corner,
wherein the web thinning begins at the transition-point and adjoins the adjacent main cutting edge in kink-free manner.

By “surface grinding”, a grinding with plane flank facets is meant, in particular a four-surface grinding.

By virtue of the interaction of the small aperture angle between 85° and 95° according to the invention with a web thinning that extends far into the center, a particularly good axial removal of chips in the center of the drilling tool is guaranteed. By virtue of the features, it is ensured that, in particular, a chip that has been taken away radially inside is guided from the web thinning directly axially along the longitudinal axis into the flute. Therefore a chip that has been taken away radially inside does not reach sections of the flute situated radially further outside. The consequence is an effective removal of chips, in particular close to the center. Furthermore, a chip that has been directly conducted away axially gives rise to only slight friction on a face of the drilling tool.

On account of the spatial curves of intersection, arising variably as a function of the grinding, of web thinning and flanks, the definitions of the aperture angle have been specified as a function of the respective grinding.

The invention preferably provides that the web thinning extends further in the direction of the imaginary connection of the drill bit to a cutting corner than the transition-point, adjoining the web thinning, between main cutting edge and transverse cutting edge. In other words, the invention preferably provides that the web thinning extends further beyond the transverse cutting edge into the center of the drilling tool than the transition-point, pertaining to the web thinning in question, between main cutting edge and transverse cutting edge. Expressed differently, the web thinning protrudes further in the direction of a central plane of division which is spanned from the connection of the cutting corners and the longitudinal axis than the transition-point between main cutting edge and transverse cutting edge. These relationships become particularly clear in a frontal view of the drill face.

The web thinning has been formed, in particular, by a single grinding operation. This is associated with the advantage that production is particularly economical. The web thinning is preferably unifacial.

The advantage of this is that a surface of the web thinning is edge-free and therefore particularly low-friction. For production, this means that the introduction with the aid of a grinding tool can be undertaken in one grinding operation, in particular in step-free manner.

In particular, the invention provides that the web thinning—coming from the adjacent main cutting edge from the direction of the associated cutting corner—is curved only after the transition-point. At the transition-point, the main cutting edge and the web thinning preferably have the same tangent (with respect to a frontal view of the drill face). Only after the transition-point does the web thinning assume a concavely curved progression. The term “concavely” is to be interpreted here in reference to the convexly curved main cutting edge—that is to say, whereas the main cutting edge vaults in the direction of the flute, the curvature of the web thinning is directed in the opposite direction. With regard to this aspect, the transition-point is more preferably a point of inflection. In particular, the main cutting edge runs into the transition-point via a straight-line section.

The drilling tool is, in particular, a twist drill with flutes extending in twisted manner.

More preferably, the drilling tool has been formed monolithically, comprising a cutting-edge section and a shank section. Alternatively, the drilling tool might take the form of a drilling head which is capable of being connected to a separate shank.

The drilling tool consists, in particular, of a hard material such as hard metal. By the term “hard metal”, a composite material is understood consisting of carbides as hard-material phase and tough metals pertaining to the iron group (Fe, Co, Ni) as binder phase. In particular, the grains of hard material are constituted by tungsten carbide. In the case of hard metal, as a rule the binder is cobalt (Co). But other metals or alloys also enter into consideration as binder. In common English parlance, hard metal is frequently also designated as “cemented carbide”. Particularly preferably, the drilling tool takes the form of a solid-carbide (SC) tool.

The two main cutting edges have an arcuate progression, at least in sections. In particular, the main cutting edges are convexly curved. The term “convexly” in this context means that the main cutting edges vault into an assigned flute.

In particular, the invention provides that the main cutting edges lead into the transverse cutting edge via a straight section. They then form an edge or a kink with the transverse cutting edge which is likewise straight with respect to a frontal view of the drill face.

The main cutting edges accordingly exhibit only a slight curvature, preferably close to the center, and are constituted, preferably close to the center, by straight-line sections. By virtue of the slight curvature close to the center, or a, more preferably, straight progression close to the center, slight cutting forces close to the center are achieved. As a result, only a low torque acts on the drilling tool.

The web thinning preferably exhibits an arcuate progression, at least in sections, with a vertex at which a curvature of the arcuate progression may have a maximum.

A radial position of the vertex with reference to the drill bit is situated, in particular, between 0.02× BR and 0.1× BR, where BR is half the diameter of the drill. In particular, the vertex is situated between 0.03× BR and 0.07× BR. This gives expression to the fact that a maximum curvature of the web thinning is particularly close to the center. Since the maximum curvature of the web thinning is so close to the center, a chip deflection occurs at low trajectory speeds and, associated with this, with slight friction and slight torque.

The invention preferably provides that at a vertex of the web thinning a tangent is capable of being constructed, the tangent normal of which to the imaginary connection of the drill bit to a cutting corner assumes an angle between 60° and 70°.

This gives expression to the fact that the web thinning exhibits a principal direction of extent, capable of being established via a maximum curvature, which in comparison with the imaginary connection between drill bit and the assigned cutting corner assumes an angle of between 60° and 70°.

At a maximum curvature a particularly strong deflection of a chip invariably occurs. By virtue of the preferred position of the maximum curvature, only slight torques, and consequently slight machining forces, arise. By virtue of the preferred position of the principal direction of extent of the web thinning, a particularly good removal of chips, close to the center, into the flute is obtained.

The invention preferably provides that an axial angle, measured in relation to the longitudinal drill axis, of the web thinning is between 30° and 40°. In particular, the axial angle of the web thinning amounts to 35°+1°. The axial angle of the web thinning is a measure of the axial “steepness” of the web thinning. A progression that is too flat—that is to say, an axial angle of, for instance, 45° or more—impairs the removal of chips into the flute. A progression that is too steep—that is to say, an axial angle of, for instance, 25° or less—elongates the web thinning and results in grinding cuts at the transitions of the web thinning to the land, which is unfavorable as regards collection of chips.

The stated preferred magnitude of the axial angle of the web thinning obtains, in particular, in the region in which the web thinning extends radially outward, in particular extends straight radially outward. More preferably, the axial angle of the web thinning is constant along the radial progression of the web thinning.

Protection is also sought for a method for producing a drilling tool, wherein a web thinning is introduced on the drill face, this comprising the following grinding steps with a grinding tool:
i) forming a web thinning, close to the center, with a vertex at which a tangent normal assumes an angle between 60° and 70°;
ii) forming an adjoining section of the web thinning by virtue of a straight radially outward movement of the grinding tool. In the method according to the invention there is provision, after creation of the radius, close to the center, of the web thinning, to guide the grinding tool radially outward via a straight grinding path. The straight path is preferably oriented at between 85° and 95° with respect to the connection of drill bit and cutting corner. It will be obvious to a person skilled in the art that yet further operations are required for producing a drilling tool. In the present paragraph, only steps in connection with the creation of the web thinning will be considered.

Further advantages and efficacies of the invention will become apparent with the aid of the following description of embodiments with reference to the appended FIG.

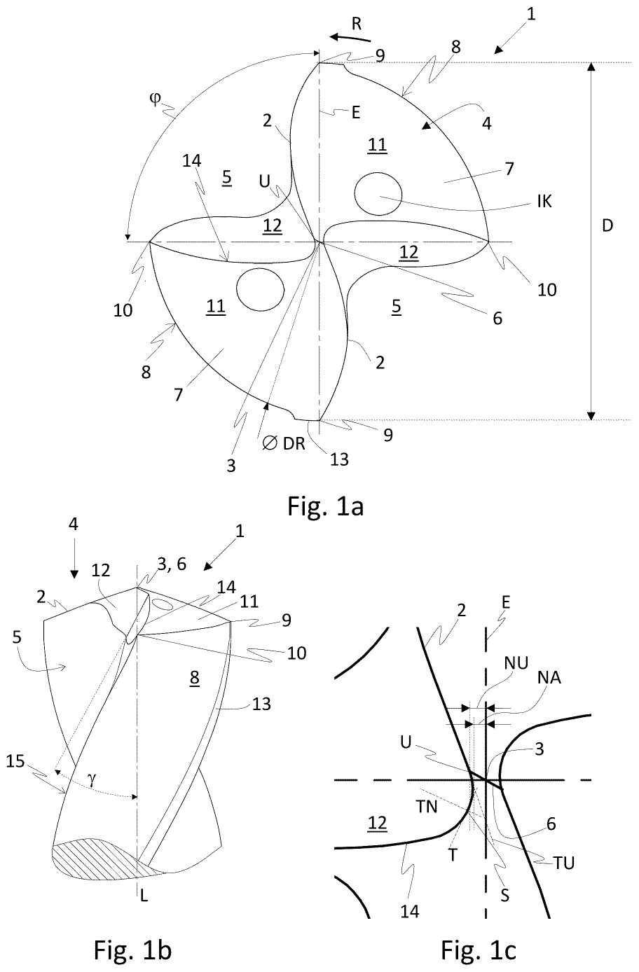

FIGS. 1a-d: show a drilling tool according to a first embodiment in different views

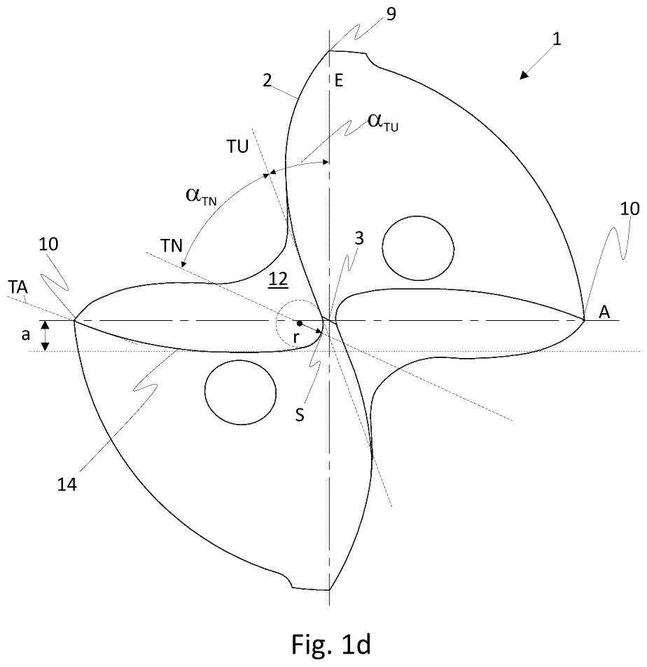

FIGS. 2a-b: show a drilling tool according to a second embodiment in different views

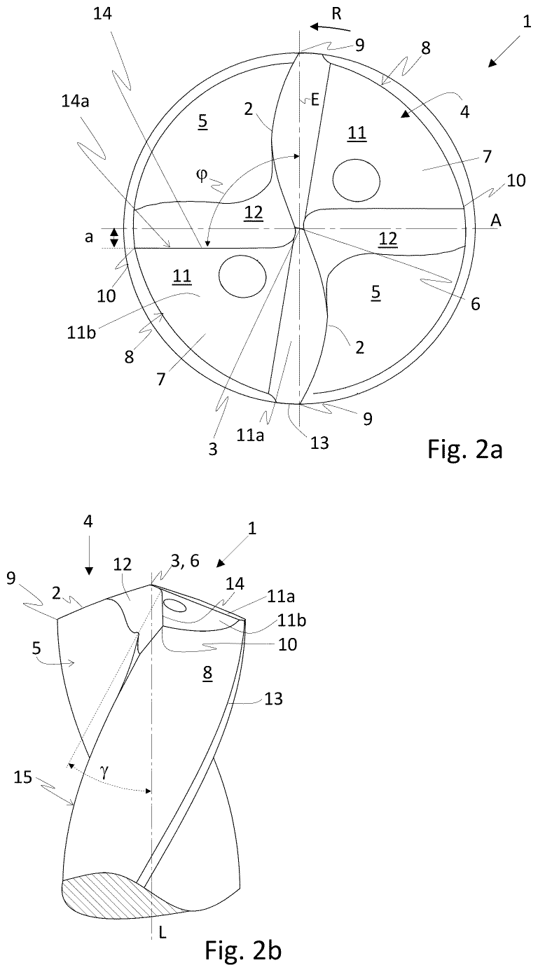

FIGS. 3a-f: show schematic representations of a method for production in the case of a conical-surface grinding

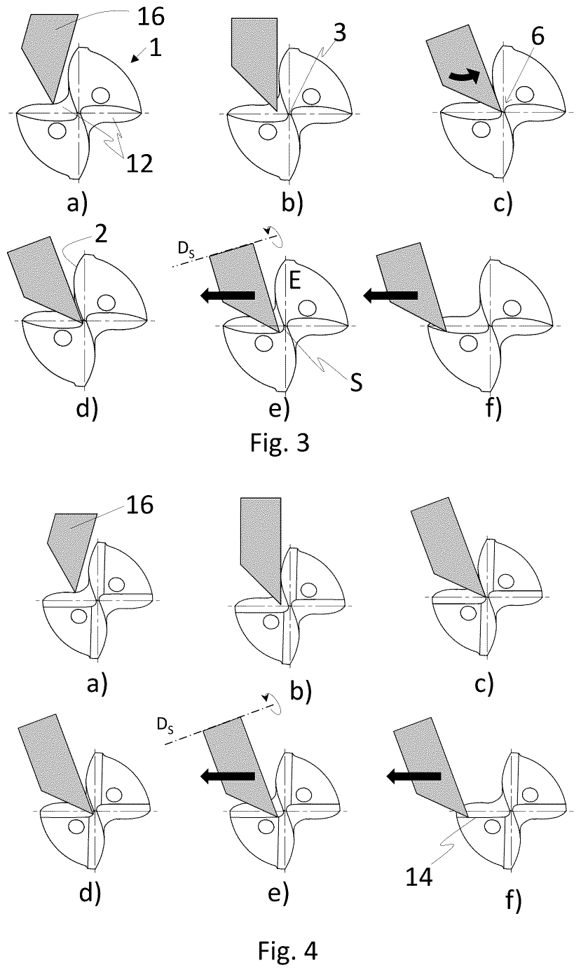

FIGS. 4a-f: show schematic representations of a method for production in the case of a four-surface grinding.

FIG. 1a shows schematically a drilling tool 1 according to a first embodiment in a frontal view of a front side of the drilling tool 1, designated as drill face 4. The line of sight runs parallel to a longitudinal axis L of the drilling tool 1, which also constitutes the central axis and in the present representation is consequently projecting.

Two main cutting edges 2 which are connected to one another via a transverse cutting edge 6 have been formed on the drill face 4.

The drilling tool 1 according to the invention is a 2-cutter with two main cutting edges 2.

The main cutting edges 2 preferably display a vaulted progression in the direction of rotation R. In other words, the main cutting edges 2 are curved in arcuate manner, with a vertex of the arcuate progression extending in the direction of rotation R. One speaks of convex main cutting edges 2: An arcuate shape, at least in sections, of the main cutting edge 2 brings about a robust cutting edge and a gentle cut.

The main cutting edges 2 preferably exhibit an S-shaped progression in an overall view.

The main cutting edges 2 preferably run into the transverse cutting edge 6 via straight sections. This means that each main cutting edge 2 preferably comprises an arcuate section radially on the outside and a straight section radially on the inside.

The drilling tool 1 is capable of being rotated along its longitudinal axis L, in which connection in the present case a direction of rotation R has been provided. The present drilling tool 1 is accordingly dextrorotatory. The invention can also be applied to levorotatory tools. A flute 5 which extends at a twist angle along the longitudinal axis L is located in each instance ahead of a main cutting edge 2 with respect to the direction of rotation R.

Shown, furthermore, are outlet apertures of internal coolant ducts IK which may optionally be present.

The foremost point of the transverse cutting edge 6 constitutes a drill bit 3 situated on the longitudinal axis L.

In particular, the drilling tool 1 has been divided into equal parts-that is to say, the main cutting edges 2 are distributed along 180°. A connection of opposing cutting corners 9 contains the drill bit 3.

In addition, the two main cutting edges 2 have preferably been constructed identically; one speaks of a symmetrical drilling tool 1 divided into equal parts. Webs 7 have been formed between the flutes 5. A land 8 is located on an outer periphery of the webs. In the present embodiment, guide chamfers 13 have been formed which are situated on the drilling diameter D. The land 8 is situated opposite that, reset on a land diameter DR.

A flank 11 adjoins behind each main cutting edge 2 with respect to the direction of rotation R. In the present embodiment, the drill face 4 is endowed with a conical-surface grinding-that is to say, the flanks 11 have been formed by segments of a conical surface.

A web thinning 12, by which the transverse cutting edge 6 has been reduced to a desired dimension, has been introduced into the flank 11 on the drill face 4.

The flank 11 extends on the periphery from a cutting corner 9 to a rear corner 10 at which the flank 11 merges into the flute 5, forming an edge. In other words, in a frontal view of the drill face 4 the rear corner 10 is that point situated on the outer periphery at which the land 8 and the contour 14 of the web thinning 12 intersect. The line of intersection between the web thinning 12 and the flank 11 is designated as the contour 14 of the web thinning 12.

The contour 14 of the web thinning 12 also marks the transition of the flank 11 into the flute 5. The web thinning 12 is to be regarded as appertaining to the flute 5.

In the present frontal view of the drill face 4, an aperture angle φ of a flute 5 can be defined on the drill face 4, which aperture angle φ is spanned between
an imaginary connection of the drill bit 3 to a cutting corner 9 of the main cutting edge 2 and, following thereupon in the direction of rotation R,
an imaginary connection of the drill bit 3 to the rear corner 10 which has been formed on the land 8 at the transition of the flank 11 into the flute 5, the aperture angle φ amounting to between 85° and 95°.

This definition of the aperture angle φ holds for drilling tools with conical-surface grinding. The aperture angle φ is preferably 90°±2°.

In the present embodiment, and more preferably, the aperture angle amounts to 90°.

It is to be noted that the curved progression of the web thinning 12 along the contour 14 arises by virtue of the conical shape of the drill face 4 in this embodiment. In the course of introducing the web thinning 12 by grinding, the grinding disk preferably executes a straight path from radially inside to the outside and preferably at a constant height with respect to the longitudinal axis L.

For further observations, a plane of division E is defined which divides the drilling tool in the middle and which contains the longitudinal axis L and the connection of the cutting corners 9.

The web thinning 12 begins at a point of intersection, designated as a transition-point U, between the main cutting edge 2, adjoining the web thinning 12, and the transverse cutting edge 6.

The web thinning 12 has been formed in such a manner that with respect to a normal spacing from the imaginary connection of the drill bit 3 to the cutting corner 9 it extends at least equally far in the direction of a center—that is to say, in the direction of the plane of division E—of the drilling tool 1 as the transition-point U. In particular, the web thinning 12 extends further in the direction of the imaginary connection of the drill bit 3 to the cutting corner 9 than the transition-point U. Expressed otherwise, the web thinning 12 protrudes further in the direction of the plane of division E than the transition-point U connected to the web thinning 12. In other words, the web thinning 12 protrudes beyond the transverse cutting edge in the direction of the plane of division E.

By virtue of the distinctness of the web thinning 12, additional chip space is created close to the center.

In addition, an advantageous discharge of chips is made possible through the combination of the aperture angle φ and the special geometry of the web thinning 12.

Since the web thinning 12 extends far into the center and exhibits a maximum curvature close to the center, chips undergo a strong deflection close to the center and are steered into the flute 5 close to the center. As a result, a significant portion of the chip deflection happens at low trajectory speeds and gives rise to slight forces.

The advantageous discharge of chips in combination with the increased chip space in the center of the drilling tool 1 results in significantly slighter cutting forces and therefore in reduced mechanical loads for tool and workpiece.

In the region of the transverse cutting edge 6 the web thinning 12 passes out of the main cutting edge 2, preferably in kink-free manner, in particular tangentially. Expressed otherwise, at the transition-point U the web thinning 12 adjoins the adjacent main cutting edge 2 in kink-free manner, in particular tangentially.

By a “tangential” transition, it is meant that, according to this preferred development, the main cutting edge 2 and the contour 14 of the web thinning 12 have the same tangent at the transition-point U.

By virtue of a kink-free, in particular tangential, transition of main cutting edge 2 and web thinning 12, a particularly gentle and uniform formation of chips is guaranteed.

FIG. 1b shows a side view of the drilling tool 1 from FIG. 1a. In this view, the rear corner 10 can advantageously be defined as the point of intersection of a posterior edge 15 of the land 8 with the contour 14 of the web thinning 12, which contour 14 marks the transition of the flank 11 into the flute 5.

In FIG. 1b, an axial angle γ, measured in relation to the longitudinal drill axis L, of the web thinning 12 has furthermore been inscribed.

The invention preferably provides that the axial angle γ of the web thinning 12 is between 30° and 40°. In particular, the axial angle of the web thinning amounts to 35°±2°, more preferably 35°+1°. The axial angle is measured, in particular, in the region of the web thinning 12 where the web thinning 12 extends radially outward, in particular extends radially outward along a straight line-segment.

FIG. 1c shows a detailed view of the representation shown in FIG. 1a—t hat is to say, a frontal view of the drill face 4 along the longitudinal axis L.

With the aid of this detailed view, the distinctness, according to the invention, of the web thinning 12 becomes even more apparent.

In accordance with the invention, the web thinning 12 extends far into the center to such an extent that a normal spacing NA of an interior point of the web thinning 12 from the imaginary connection of the drill bit 3 to the cutting corner 9 is less than or equal to the normal spacing NU of the transition-point U between the main cutting edge 2, adjoining the web thinning 12, and the transverse cutting edge 6 from the imaginary connection of the drill bit 3 to a cutting corner 9 (no longer in the image).

In other words, the contour 14 of the web thinning 12 extends at least as far into the center of the drilling tool 1 as the transition-point U adjoining the web thinning 12. The contour 14 of the web thinning 12 leads further into the center than the transition-point U. Expressed otherwise, the web thinning extends as far as “behind” the transverse cutting edge 6. By way of measurement of the spacing from the center, the normal spacing from the plane of division E is meant, not necessarily a spacing from the drill bit 3.

Furthermore, a principal direction of extent of the web thinning 12 can be defined:
the web thinning 12 exhibits, close to the center, a vertex S at which the curvature of the contour 14 of the web thinning 12 may have a maximum. If the web thinning 12 is continuously curved close to the center, for instance along a radius of curvature, the vertex S in the middle of the continuous curvature progression can be established.

A tangent T can be established at the vertex S. A tangent normal TN extending normally to the tangent T establishes the principal direction of extent of the web thinning 12.

At the transition-point U between the assigned main cutting edge 2 and the transverse cutting edge 6, at which transition-point U the web thinning 12 adjoins the main cutting edge 2 in kink-free manner, the main cutting edge 2 and the web thinning 12 exhibit (with respect to the chosen frontal view, evident from the contour 14) a common tangent TU at the transition-point U.

FIG. 1d shows, once again, the same embodiment in a frontal view of the drill face 4. For the sake of clarity, further aspects of the invention will be elucidated with the aid of this separate figure. Likewise for reasons of clarity, not all reference symbols are inscribed.

The web thinning 12 accordingly exhibits, close to the center, a groove with a radius of curvature. A radius of curvature—r—of the web thinning 12 at the vertex S preferably amounts to between 0.06 and 0.09× D, where D is the drilling diameter. More preferably, the radius of curvature—r—of the web thinning 12 amounts to between 0.07 and 0.08× D, in particular 0.075× D. Alternatively, the relevant circle of curvature with radius of curvature—r—has been inscribed as radius.

The tangent TU to the main cutting edge 2 at the transition-point U with the imaginary connection between drill bit 3 and cutting corner 9 preferably assumes an angle α_{TU} between 10° and 30°, more preferably an angle α_{TU} between 15° and 25°, still more preferably an angle between 17° and 23°. In particular, angle α_{TU} amounts to 20°±2°.

The principal direction of extent of the web thinning 12, established by the tangent normal TN, includes with the tangent TU at the transition-point U an angle α_{TN} between 30° and 60°, in particular an angle α_{TN} between 40° and 50°, more preferably an angle α_{TN} between 42° and 48°. An angle α_{TN} of 45°±2° has proved to be particularly favorable, in particular as regards a removal of chips from the radially interior section of the main cutting edge 2.

More preferably, the principal direction of extent of the web thinning 12, established by the tangent normal TN, includes with the imaginary connection between drill bit 3 and cutting corner 9 an angle between 60° and 70°. In particular, this angle is 65°±2°.

This orientation has proved to be particularly favorable for a chip deflection and chip removal close to the center.

Furthermore, a beyond-center dimension a of the web thinning 12 can be specified:
the beyond-center dimension—a—specifies how far the web thinning 12 extends maximally over an equator plane A which runs at 90° in comparison with the plane of division E and contains the longitudinal axis L.

In the present example with an aperture angle φ of 90°, the track of the equator plane A coincides with the connection of the two opposing rear corners 10.

The beyond-center dimension—a—of the web thinning 12 preferably amounts to between 5% and 15% of the drilling diameter D, more preferably 10%±2% of the drilling diameter D.

The main cutting edge 2 preferably runs into the transition-point U via a straight section. As a result, main cutting edge 2 and transverse cutting edge 6 form a kink at the transition-point U.

The transverse cutting edge 6 preferably assumes with the imaginary connection between drill bit 3 and cutting corner 9 an angle between 50° and 70°, in particular an angle of 60°±2°.

Together with the preferred orientation, already discussed, of the main cutting edge 2 at the transition-point U, it consequently follows as being particularly preferred that the main cutting edge 2 and the transverse cutting edge 6 assume an exterior angle of 140°+4° at the transition-point U.

The drilling tool 1 has, in particular, been configured symmetrically-that is to say, the geometrical features discussed apply to both flutes 5. In other words, the drilling tool 1 can be transposed into itself by a 180° rotation along the longitudinal axis L.

FIGS. 2a and 2b show different views of a drilling tool 1 according to a further embodiment.

FIG. 2a shows a frontal view of the drill face 4 of a drilling tool 1 according to the invention.

In the embodiment, a so-called 4-surface grinding has been formed on the drill 14 face 4.

In the case of a 4-surface grinding, the flank 11 comprises two partial facets 11a and 11b. The partial facets 11a, 11b of the flank 11 exhibit different clearance angles. The partial facets 11a, 11b of the flank 11 are preferably plane-that is to say, not vaulted.

The aperture angle φ is defined for a grinding with plane flank facets, as in the case of the 4-surface grinding here, as being spanned between:
an imaginary connection of the drill bit 3 to the cutting corner 9 of the assigned main cutting edge 2 and
the section of the contour 14 of the web thinning 12 extending radially outward,

the aperture angle φ amounting to between 85° and 95°. The aperture angle φ is preferably 90°+2°. In the present embodiment, and more preferably, the aperture angle amounts to 90°.

By “the section of the contour 14 of the web thinning 12 extending radially outward”, that section of the web thinning 12 is understood which adjoins the near-center curvature of the web thinning 12 and for a grinding with plane flank facets extends substantially straight radially outward.

The invention preferably provides that in the case of a drilling tool 1 with a surface grinding the contour 14 of the web thinning 12 exhibits a straight progression, at least in sections, in the frontal view of the drill face 4, which straight section in this case is preferably drawn upon as second shank for the definition of the aperture angle φ.

Such a straight progression arises, for instance, by virtue of a straight grinding path in the course of production of the web thinning 12 by means of a grinding tool.

In particular, the contour 14 of the web thinning 12 exhibits a radially exterior straight section 14a.

By the “radially exterior straight section 14a of the web thinning 12, that straight section 14a of the contour 14 of the web thinning 12 is meant, via which the web thinning 12 leads into the rear corner 10.

This straight section 14a is then drawn upon as second shank in the determination of the aperture angle φ.

For better comprehension, let it be explained that the web thinning 12 is introduced, in particular, in such a manner that a grinding disk firstly reproduces the radially interior rounding of the web thinning 12 and then generates the remaining contour 14 of the web thinning 12 along a straight path from radially inside to the outside and preferably at a constant height with respect to the longitudinal axis L. Since the web thinning 12 in the present embodiment has been introduced into a plane flank 11, a straight path of a grinding disk is also reproduced as a straight-line section of the contour 14 of the web thinning 12.

Also for this practical form with a grinding with plane flank facets, a beyond-center dimension a of the web thinning 12 can be specified: the beyond-center dimension—a—specifies how far the web thinning 12 extends maximally over an equator plane A which runs at 90° in comparison with the plane of division E and contains the longitudinal axis L.

The beyond-center dimension-a-of the web thinning 12 preferably amounts to between 5% and 15% of the drilling diameter D, more preferably 10%±2% of the drilling diameter D.

The configuration of the web thinning 12 is analogous to the embodiment discussed previously with conical-surface grinding. In particular, the details relating to the curvature, to the principal direction of extent, and to the preferred dimensions of the web thinning 12, apply to all the practical forms, whether it be a drilling tool 1 with conical-surface grinding or with surface grinding with plane flank facets.

In FIG. 2b, an axial angle γ, measured in relation to the longitudinal drill axis L, of the web thinning 12 has furthermore been inscribed.

The invention preferably provides that the axial angle γ of the web thinning 12 is between 30° and 40°. In particular, the axial angle of the web thinning amounts to 35°±1°. The axial angle of the web thinning is a measure of the axial “steepness” of the web thinning.

All the developments and advantages discussed apply equally to all the embodiments.

FIGS. 3a-f illustrate a preferred method for introducing the web thinning 12 in the case of a drilling tool 1 with a conical-face grinding. For better comprehension, the contours of the web thinning 12 have already been inscribed from the beginning. It will be understood that the contours of the web thinning 12 arise only from the sequence of operations shown here for introducing the web thinning 12. For reasons of clarity, reference symbols have been allocated only to individual drawings.

A grinding tool 16—in the present case, a grinding disk—is firstly moved in the direction of the drill bit 3. A rotation of the grinding tool 16 occurs along an axis of rotation Ds.

Subsequently, the part of the web thinning 12 close to the center is ground in such a manner that the vertex S of the web thinning is situated, relative to the plane of division E, “behind” the point of intersection of the transverse cutting edge 6 with the main cutting edge 2, steps d)-e) of the representation.

Lastly, the grinding tool 16 is guided radially outward along a straight grinding path, step f) of the representation.

FIGS. 4a-f illustrate a preferred method for introducing the web thinning 12 in the case of a drilling tool 1 with 4-surface grinding.

The sequence of operations is undertaken in a manner analogous to the method explained with aid of FIGS. 3a-f. Repetition of the reference symbols is dispensed with.

On account of the plane flank, the radially tapering contour 14 of the web thinning 12 arises here as a straight-line segment.

### LIST OF THE REFERENCE SYMBOLS USED

1 drilling tool
2 main cutting edge
3 drill bit
4 drill face
5 flute
6 transverse cutting edge
7 web
8 land
9 cutting corner
10 rear corner
11 flank
12 web thinning
13 guide chamfer
14 contour of the web thinning
15 posterior edge of the land
16 grinding tool

1-12. (canceled)

13. A drilling tool, comprising:
two main cutting edges having, at least in sections, an arcuate progression, said two main cutting edges being connected to one another via a transverse cutting edge;
a drill face;
a longitudinal drill axis about which the drilling tool is rotated in a direction of rotation;
a drill bit situated on the longitudinal drill axis;
two flutes extending along the longitudinal drill axis;
webs formed between said flutes and form a land peripherally;
a web thinning introduced into said drill face;
wherein, relative to a frontal view of said drill face, an aperture angle of a flute of said flutes has been formed on said drill face, which in a case of a conical-surface grinding of said drill face is defined as being spanned between:
an imaginary connection of said drill bit to a cutting corner of a main cutting edge of said main cutting edges; and
an imaginary connection of said drill bit to a rear corner which has been formed on said land at a transition of a flank into said flute;
in a case of a surface grinding, said drill face is defined as being spanned between:
the imaginary connection of said drill bit to said cutting corner of said main cutting edge; and
a section of a contour of said web thinning extending radially outward;
said aperture angle is in a range of between 85° and 95°;
said web thinning being introduced into said drill face such that a normal spacing of an interior point of said web thinning from the imaginary connection of said drill bit to said cutting corner is less than or equal to a normal spacing of a transition-point between said main cutting edge, adjoining said web thinning, and said transverse cutting edge from the imaginary connection of said drill bit to said cutting corner; and
said web thinning begins at the transition-point and adjoins an adjacent said main cutting edge in kink-free manner.

14. The drilling tool according to claim 13, wherein said web thinning extends further in a direction of the imaginary connection of the drill bit to the cutting corner than the transition-point, adjoining said web thinning, between said main cutting edge and said transverse cutting edge.

15. The drilling tool according to claim 13, wherein said web thinning exhibits, relative to a frontal view of said drill face, an arcuate progression, at least in sections, with a vertex, a radial position of which with reference to said drill bit is situated between 0.1× BR and 0.33× BR, where BR is half a drilling diameter.

16. The drilling tool according to claim 13, wherein the transition-point between said main cutting edge and said transverse cutting edge constitutes a point of inflection with respect to a curvature of said web thinning.

17. The drilling tool according to claim 13, wherein said web thinning and said main cutting edge exhibit a common tangent at the transition-point between said main cutting edge and said transverse cutting edge.

18. The drilling tool according to claim 13, wherein at a vertex of said web thinning a tangent is capable of being constructed, a tangent normal of which establishes a principal direction of extent of said web thinning, which with a tangent at the transition-point between said main cutting edge and said transverse cutting edge assumes an angle between 30° and 60°.

19. The drilling tool according to claim 13, wherein at a vertex of said web thinning a tangent is capable of being constructed, a tangent normal of which establishes a principal direction of extent of said web thinning, which assumes an angle between 60° and 70° in relation to the imaginary connection of said drill bit to said cutting corner.

20. The drilling tool according to claim 13, wherein a tangent to said main cutting edge at the transition-point between said main cutting edge and said transverse cutting edge assumes an angle between 10° and 30° with the imaginary connection between said drill bit and said cutting corner.

21. The drilling tool according to claim 13, wherein said web thinning exhibits a maximum curvature close to a center, with a radius of curvature between 0.06 and 0.09× D, where D is a drilling diameter.

22. The drilling tool according to claim 13, wherein said web thinning is unifacial.

23. The drilling tool according to claim 13, wherein an axial angle, measured in relation to the longitudinal drill axis, of said web thinning amounts to between 30° and 40°.

24. A method for producing a drilling tool, which comprises the steps of:
introducing a web thinning on a drill face of the drilling tool, which includes the following grinding steps using a grinding tool:
forming the web thinning close to a center, with a vertex at which a tangent normal assumes an angle between 60° and 70°; and
forming an adjoining section of the web thinning by virtue of a straight radially outward movement of the grinding tool.
